(19) United States
(12) Patent Application Publication
(10) Pub. No.: US 2022/0004686 A1
(43) Pub. Date: Jan. 6, 2022

(54) METHOD FOR DETERMINING DESIGN PARAMETERS OF A ROTOR BLADE

(71) Applicant: Fraunhofer-Gesellschaft zur Förderung der angewandten Forschung e.V., München (DE)

(72) Inventor: Malo Rosemeier, Bremerhaven (DE)

(21) Appl. No.: 17/289,969

(22) PCT Filed: Oct. 28, 2019
(86) PCT No.: PCT/EP2019/079413

§ 371 Date: Apr. 29, 2021

(30) Foreign Application Priority Data
Oct. 29, 2018 (DE) 10 2018 218 516.6

(51) Int. Cl. G06F 30/23; G06F 30/17

(52) U.S. Cl. CPC G06F 30/23; G06F 2111/10; G06F 30/17

(57) ABSTRACT

The invention relates to a method for determining design parameters (41) of a rotor blade (3, 4, 5) of a machine interacting with a fluid, in particular of a wind turbine, in which quality parameters (39) of the rotor blade are determined non-destructively, in particular by way of measurements, in which target parameters of the rotor blade (40) are determined, and in which the determined target parameters are predefined in an optimization process (33), wherein the design parameters are varied in the optimization process in such a way that the target parameters are achieved, taking the determined quality parameters into consideration. In this way, it is possible to determine the parameters of a present rotor blade which can be non-destructively determined, so as to determine the parameters that cannot be determined non-destructively, or that are difficult to determine, by way of a computer model.

### CROSS REFERENCE TO RELATED APPLICATIONS

The present application is a national stage application of International Application No. PCT/EP2019/079413, filed Oct. 28, 2019, which claims priority to German Application No. DE102018218516.6, filed Oct. 29, 2018, the disclosures of which are hereby incorporated by reference in their entireties.

### FIELD OF THE DISCLOSURE

The invention resides in the mechanical engineering field, and in particular in the field of wind energy technology, and can be used particularly advantageously during the numerical modeling or simulation of the behavior of wind turbines.

### BACKGROUND OF THE DISCLOSURE

In many application cases, such as during the analysis on the occasion of service life extensions or certifications, a model of the whole system has to be created for an existing wind turbine, which allows the simulation of certain operating and load states. In addition, wind farm operators or individuals charged with conducting maintenance on wind farms have to analyze the causes of outages, damage or complete failure of wind turbines on a regular basis. A virtual model of a whole system is also used for these applications, for example so as to carry out simulations or load calculations.

The quality of simulation models depends on the degree of detail of the information available about the components. In the case of existing wind turbines, which frequently are several years old, often only fragmentary information as to the design of the system, and in particular as to the design of the rotor blades, is available. As a result, reverse engineering methods should also be utilized during the creation of the most detailed simulation models possible, to non-destructively determine as much detail as possible about the system, and in particular about the design of rotor blades.

The parameters of the rotor blades have a particularly great influence on the simulation model and should therefore be determined with particular diligence and effort. Some of the parameters are easily determinable by exterior measurement or are apparent from the manufacturing or delivery documents. Other parameters, such as the modal parameters of the vibration modes, are determinable by way of measurement in different operating states or by experimentation. There are further parameters which can only be determined with great complexity and/or by destroying individual rotor blades.

For example, a method for measuring a wind turbine using optical scanning is known from DE 296 09 242.

DE 11 2008 001 197 T5 discloses a special method for the contact-free measurement of a wind turbine blade.

US 2005/0067568 A1 discloses a method in which a rotor blade is measured from the outside, wherein thickness values from a map are assigned to the points of the surface, whereby it is possible to reconstruct inner surfaces of the hollow rotor blade.

Against the background of the known methods for analyzing elements of wind turbines, it is the object of the present invention to create a method by means of which parameters of rotor blades of a wind turbine, or also of another machine interacting with a fluid, such as a gas turbine or a water turbine, which are not easy to measure can be determined as non-destructively as possible, with as little complexity as possible, and with great attention to detail.

### SUMMARY

In one aspect, an object is achieved according to the invention by the features recited in the claims.

The invention accordingly relates to a method for determining design parameters of a rotor blade of a machine interacting with a fluid, in particular of a wind turbine, in which quality parameters of the rotor blade are determined non-destructively, in particular by way of measurements, in which target parameters of a rotor blade are determined, in particular by way of measurements, and in which the determined target parameters are predefined in an optimization process, wherein the design parameters are varied in the optimization process in such a way that the target parameters are achieved, taking the determined quality parameters into consideration.

In the case of an available wind turbine, or at least a present, accessible and available rotor blade, the method according to the invention thus pursues the avenue of finding out the parameters that can be determined relatively easily by measuring or visually inspecting the wind turbine, or by reviewing the manufacturing documents, and to use these as a basis for an optimization method. Known optimization methods include the established linear or non-linear optimization methods, using computer programs. Known optimization algorithms for such purposes are, for example, sequential quadratic programming (SQP) or genetic algorithms (GA). Software program packages, such as OpenMDAO or PyOpt, a program package based on the programming language Python, are available for such modeling.

Target parameters that can be used for the optimization can be, for example, modal parameters determinable or determined by way of measurement during operation or in test configurations. Such modal parameters may be understood to mean the dynamic properties, in particular the vibration properties, of a rotor blade with different vibration modes, such as flexural vibration modes or torsional vibration modes, or also coupled vibration modes. Both the natural frequencies and the respective eigenforms may be used in the process, which can be defined by the position of the vibration nodes. In many instances, it is also possible to determine the target parameters in this way entirely by measurements.

In the course of the optimization method, design parameters of the rotor blade, which are unknown before the optimization method and cannot simply be determined by visual inspection or measurement, in particular non-destructive measurement, are changed in such a way that the target parameters are achieved as fully as possible. When the optimization method is carried out, the quality parameters can be kept constant, for example, or be varied considerably less extensively than the design parameters. For example, the quality parameters can at most be varied to a degree that corresponds to the particular measuring inaccuracy. In this way, the initially unknown design parameters can be determined using the aforementioned method. Usually, one or more design parameters are selected from a number of possible design parameters and changed in this way. This is described in greater detail below. Possible design parameters include the typical parameters of a rotor blade that are determinable non-destructively from the outside and significantly influence the target parameters.

According to one embodiment of the method, the quality parameters used in the optimization process include one or more of the following parameters: infusion material used, core material used, fiber material used, fiber volume content, outer dimensions of the rotor blade, in particular length, width of the rotor blade, angle of the exterior surfaces of the rotor blade, cross-sectional shapes for one or more positions along the rotor blade, position of the profile center axis in the coordinate system of the rotor blade for one or more cross-sections.

Rotor blades can be produced, for example, in the vacuum assisted resin transfer molding (VARTM) infusion process, during which reinforcement textiles and core materials are saturated (infused) with an infusion material, such as epoxy resin, under vacuum.

The infusion material and core material used and the parameters thereof can be established, for example, by visual inspection or by perusal of the manufacturing documents. With this, it is also possible to determine the mechanical properties of the infusion material or of the composite material and of the core material and of the fiber reinforcement, such as the modulus of elasticity and the fracture strength and ductility, as well as the density, and to use these as quality parameters. The same applies to the fiber material used. For example, the fiber volume content can be learned from the manufacturing documents or derived from empirical quantities. The fiber volume content can, for example, be dependent on the reinforcement textiles used, core materials, and the infusion material, as well as the employed infusion process, which can likewise be taken into consideration. The material safety factors and the reserve factors used as a basis during construction can be derived either from the manufacturing documents, or the design guidelines of the manufacturer, or also the specifications provided at the time of the production of the wind turbine, for example by regulatory authorities and/or accredited certification institutes.

The outer dimensions of the rotor blade can be determined by way of methods that are known per se, such as laser scanning or mechanical measurement. These outer dimensions encompass the length of the rotor blade, the depth and thickness, that is, in particular also the depth and thickness profiles thereof along the length, as well as the angles of the outer surfaces or, for example, the angle of the chord of the rotor blade profile in relation to the direction of movement of the rotor blade in the rotation plane (t direction). In principle, it is also possible to use the cross-sectional shape and the position of the cross-section of a rotor blade at any point along the rotor blade longitudinal axis as quality parameters.

A meaningful selection of the quality parameters can, for example, include the infusion material used, the fiber and core material used, the fiber volume content, and the length and width or depth and thickness, that is, in particular the depth profile and thickness profile, of the rotor blade. However, a subset of these parameters is also conceivable as a selection, or one or more of the parameters described above can be added.

The material safety factors, on which the construction was based, as well as reserve factors, on which the construction was based, can also be added as additional assumptions, under certain conditions, to the quality parameters.

Material safety and reserve factors are useful as parameters to be additionally assumed in connection with an additionally conducted strength, stability and/or fatigue analysis. These additional analyses can be integrated into the optimization calculation or be carried out simultaneously therewith, so as to determine additional parameters that are incorporated as assumptions in the optimization calculation. In this case, load assumptions become necessary, which can be determined by way of aeroservoelastic simulations with the wind field and controller, and by way of further assumptions and examinations. As an alternative, a calculation can also be carried relatively easily using simplified load assumptions based on the modeling of quasi-static aerodynamic and/or gravitation-induced load states.

Aerodynamic loads can be generated by way of polar charts for the aforementioned purpose, which are calculated from a certain number of 2D cross-sections and the coordinates thereof using a panel method (for example Xfoil).

Gravitation-induced loads or dynamic loads can be determined with the aid of the assumption of structural characteristic values. If a strength, buckling and/or fatigue calculation is carried out during the optimization, the load assumption first has to be updated based on the varied structure.

Reserve factors can be predefined as additional parameters in the range of approximately 1 to 10, as boundary conditions, during the optimization process.

Another embodiment of the method can provide, for example, that the design parameters determined during the optimization process encompass one or more of the following parameters: type and thickness of the material layers of the shell, in particular in the load-bearing regions, reinforcement textiles used, the position and width of webs and flanges, if multiple webs are present, the distance or distances from one another, and if multiple webs are present, the angle with respect to one another.

The design parameters are those parameters that are to be determined in the course of the described optimization process.

The design parameters thus predominantly relate to those variables and parameters which cannot be established by way of a visual inspection of a rotor blade from the outside or by simple analysis methods, or in which greater uncertainty exists in terms of the knowledge, or in which greater error tolerances exist with corresponding assumptions, than with the quality parameters. Examples include: the positions, width and thickness of the flanges and the webs.

The thickness and structure of the material layers in the load-bearing regions also cannot be readily determined. The same applies to reinforcement textiles. This relates to the combination of the orientations and angular deviations of the fiber longitudinal directions of consecutive fiber reinforcement layers and/or the configuration of pultrudates. Here, on the one hand, certain basic textile types are customary, such as having an offset of consecutive reinforcement fiber layers in each case of 90 degrees, 45 degrees or 30 degrees with respect to the longitudinal axes of the fibers. On the other hand, it is possible to use pultrudates without transverse fibers. Accordingly, several standard textile types are often assumed by way of experimentation during the variation of the reinforcement textiles in the course of the optimization process. The remaining aforementioned design parameters are usually changed steadily within the scope of the optimization process until the target parameters are achieved. Achieving the target parameters shall be understood in the numerical sense to mean achieving these within defined boundaries. The boundaries can be established in advance, for example.

A minimum selection of design parameters can, for example, comprise the number and position of flanges and webs, and the stiffness and mass distribution of the webs as well as the flanges. For example, the stiffness and mass distribution of the non-load-bearing regions of the two half shells of a rotor blade can be added to this minimum selection.

Instead of the stiffnesses and masses of load-bearing and non-load-bearing regions, the reinforcement textiles can also be selected together with the fiber volume content and the thickness of the composite made up of the textile and infusion matrix, to serve as design parameters.

The design parameters can also include the strength, stiffness and mass of one or more flanges, the position, width in the s direction and height in the t direction of one or more webs, the stiffness and mass of one or more webs in the t direction and/or the stiffness and mass of one or more webs in the s direction, if additionally, or in combination with the optimization calculation, a strength and/or fatigue calculation is carried out, and in this way additional unknown parameters are determined. Usually, however, basic assumptions regarding the textile types and thicknesses, the matrix and fiber volume content as well as the core material thicknesses of the lightweight construction material of the entire cross-sections of the rotor blade, including the webs, and in particular also the thickness of the flanges, are made during the optimization calculation, and thus corresponding parameters are presupposed.

In addition, it may be provided, for example, that the target parameters used during the optimization process include one or more of the following parameters: dynamic properties, modal properties, in particular the first and/or second natural frequencies of the rotor blade and/or the eigenform of the rotor blade with respect to the first and/or second natural frequencies, the total mass, and the position of the center of mass of the rotor blade in the longitudinal direction thereof.

The aforementioned modal properties can relate to flexural vibrations and/or torsional vibrations and/or other vibration modes and/or coupled vibration modes with multiple vibration modes of different vibration forms.

The modal properties, in particular the natural frequencies of a rotor blade, can be determined particularly easily by measurements. In the process, the natural frequencies of many different flexural vibrations, in particular of the lowest ten harmonics, can be determined for different vibration modes, such as flexural vibrations and/or torsions vibrations. Likewise, the so-called eigenforms of these natural vibrations can be determined, which can be defined by the respective position of the nodes of the respective natural vibration.

It appears to be useful to predefine, as target parameters, at least the lowest two natural frequencies, as well as their eigenforms, of the flexural vibrations and/or of the torsional vibrations, or in each case the natural frequency and eigenform of the basic flexural vibration and of the basic torsional vibration. In addition, the position of the center of mass along the longitudinal axis of the rotor blade can be predefined. If this is not sufficient, additionally the total mass of the rotor blade can be predefined.

It may additionally be provided that the third and/or fourth natural frequencies and/or the eigenform with respect to the third and/or fourth natural frequencies are added to the target variables. This can relate to the natural frequencies with respect to the flexural vibrations as well as torsional vibrations or other vibration modes or coupled vibration modes.

It may also be provided that one or more of the first ten natural frequencies of the rotor blade are added to the target variables.

This too can relate to the natural frequencies with respect to the flexural vibrations as well as torsional vibrations or other vibration modes or coupled vibration modes.

The method can also be configured in that one or more of the eigenforms with respect to one or more of the first ten natural frequencies of the rotor blade are added to the target variables. This can likewise relate to the natural frequencies with respect to the flexural vibrations as well as torsional vibrations or other vibration modes or coupled vibration modes.

In the course of the provided optimization process, in one step, the non-destructively determined quality parameters can be supplied a computer program. For example, the computer program can be a finite element program. The computer program can be a shell model and/or a bar model, for example. A modal analysis can be carried out using such a computer program, in which the variables that are present in the optimization process as target parameters are determined. In addition to the quality parameters, the design parameters are also predefined for the computer program. Typically, several runs are carried out during the optimization process, during which one or more of the design parameters are varied from one run to the next. The variables numerically determined in this way, which typically differ from one another from one run to the next, are compared to the target parameters. In an iterative process, the design parameters are usually changed until the variables determined during the modal analysis achieve all target variables with a, for example, previously established accuracy. The change of the design parameters can be purposefully carried out and adapted in the process, based on tendencies found during the iterative process.

It can furthermore be provided that the quality parameters, and in particular the fiber volume content and/or the resin absorption, are corrected based on a model for the production-induced change of material parameters. In the process, the actual fiber volume content, for example, is determined, which essentially arises during the use of a certain processing method.

Another embodiment of the method can provide that a strength calculation and/or a fatigue calculation and/or a stability calculation are carried out for carrying out an optimization. The aforementioned calculations can supplement the optimization calculation or represent a portion of the optimization calculation. They can be implemented, for example, in each case by way of the finite element method. As a result of these calculations, it is also possible, for example, to establish only certain parameters or to establish upper or lower limits of these parameters for the optimization process.

In addition, it may be provided that a numerical model, for example a finite element model or an analytical model in the form of a volume, shell, plate or bar model, is used for evaluating limit states. With this method configuration, strengths, safety factors, reserve factors and loads are considered.

The method can provide that, after the design parameters have been determined, taking the quality parameters and the design parameters into consideration, an expected service life or maximum remaining usage duration or a maximum possible mechanical, static or dynamic load-bearing capacity of the rotor blade or of the machine is determined.

The invention additionally relates to a method for determining parameters for the simulation of a machine interacting with a fluid, in particular of a wind turbine, during which quality parameters and target parameters of the rotor blades are determined, in particular by non-destructive measurement, and during which design parameters of the rotor blades are determined according to a method according to the claims. Other parameters, for example of the tower or the foundation, can be measured or determined by perusing the construction documents or by assumptions, and can be added to an overall model of the wind turbine.

The invention also relates to a method for simulating a machine interacting with a fluid, in particular a wind turbine, in which parameters for the simulation are first determined, and thereupon the behavior of the machine under load is simulated, in particular for specific load cases.

In this way, it is possible to determine limit loads and load-bearing capacities, and conclusions can be derived for employing or using the wind turbine or for the outage likelihood the wind turbine.

### BRIEF DESCRIPTION OF THE DRAWINGS

The invention will be shown and described hereafter based on examples in figures of a drawing. In the drawings:

FIG. 1 shows a schematic three-dimensional view of a wind turbine;

FIG. 2 schematically shows a cross-section through a rotor blade of a wind turbine perpendicular to the longitudinal axis of the rotor blade;

FIG. 3 shows the layer composition of a rotor blade in the cross-section; and

FIG. 4 shows a schematic representation of the structure of the method according to the invention.

### DETAILED DESCRIPTION OF THE DRAWINGS

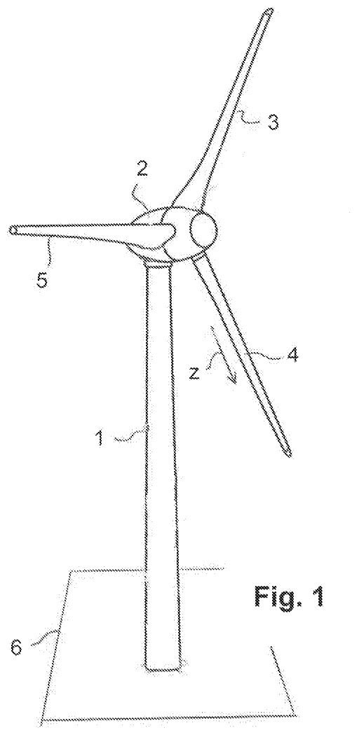

FIG. 1 shows a schematic view of a wind turbine comprising a tower 1 as well as a nacelle 2 and rotor blades 3, 4, 5. The tower 1 is anchored in a foundation 6.

A simulation model is usually created to be able to calculate the load-bearing capacity of such a wind turbine, in which all the parameters of the wind turbine are considered. The simulation model makes it possible to establish how the wind turbine behaves under certain load assumptions. From this, conclusions can be drawn as to whether the system is safe to operate under the expected conditions.

Since in many cases not all parameters of the wind turbine are available or can be determined, the simulation model may be difficult to create in some instances. Usually, the rotor has, or the rotor blades of the wind turbine have, considerable influence on the behavior of the system. It is often possible to simulate the tower and the foundation and other parts using simplified assumptions, wherein more should be invested in the simulation of the rotor so as to determine as many influential parameters as possible with the greatest accuracy possible.

Using the invention, it is possible to determine some parameters (quality parameters) relatively precisely by way of measurement or determinment from the manufacturers' documents or in another manner. Other parameters (target parameters) can be determined by measurements and/or experiments at the wind turbine, such as many modal parameters, that is, parameters that characterize vibration states of a rotor blade.

Usually, a number of quality parameters are presupposed during the concept design of a rotor blade, and other parameters are varied to achieve predefined target parameters. The invention takes advantage of this method by determining the target parameters in the case of the existing rotor blade by way of measurement. During a subsequent optimization process, the unknown parameters (design parameters) are varied in such a way that the target parameters are achieved. The design parameters thus determined are then used for a subsequent simulation.

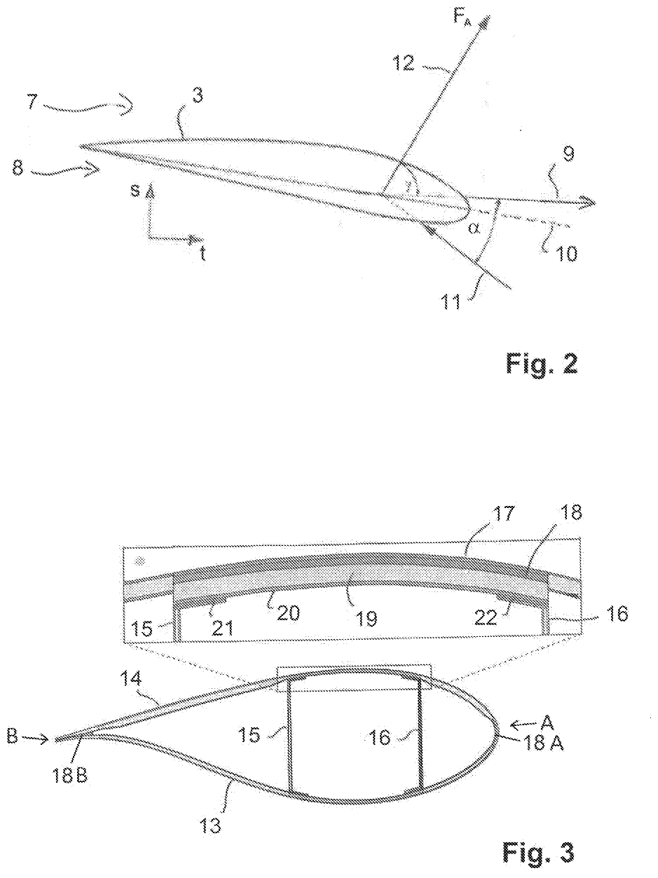

For the further discussion, based on FIG. 2 the fundamental coordinate system shall be introduced for the description of a rotor blade. FIG. 2 shows the outer surface of a rotor blade 3 in the cross-section, wherein the rotor blade has an airfoil profile including the suction side 7 and the pressure side 8. The direction of movement (edgewise direction) of the rotor blade during rotation of the rotor is denoted by arrow 9 and extends in parallel to the axis t of the plotted coordinate system. The axis s of the coordinate system describes the flapwise direction and is perpendicular to the axis t, and the axis z, as shown in FIG. 1, is perpendicular to the two aforementioned axes, which runs in parallel to the longitudinal axis of the rotor blade, perpendicular to the drawing plane. The chord of the airfoil profile is denoted by reference numeral 10. Arrow 11 denotes the inflow direction of the profile, and arrow 12 denotes the lift force FA. The angle between the chord 9 and the inflow direction 11 is denoted by a. The angle between the chord 9 and the lift force 12 is denoted by V.

FIG. 3 shows the layer composition of an exemplary rotor blade in the cross-section in a detailed representation. In many instances, rotor blades of wind turbines are substantially hollow and comprise two half shells 13, 14 that are adhesively bonded to one another and are located one each on the pressure side and suction side. The space between the inner and outer covering laminate of the half shells 13, 14 is often filled with a lightweight core material, such as a foamed material or balsa wood.

It can also be provided that the non-load-bearing structures, that is, for example, the panels, are made entirely or partially of a multi-layer sandwich-like composition, which comprises fixed covering laminates and a layer made of a lightweight core material arranged therebetween.

To impart the necessary stiffness to the rotor blade, one or more webs 15, 16 are usually attached between the half shells 13, 14, which stabilize the rotor blade, in particular with respect to bending about the t axis. The webs 15, 16 are each connected to the two half shells 13, 14, for example by means of an adhesive bond.

Flanges, which are usually made of a very tension-resistant material, are provided between the webs 15, 16 in the region of the skins of the half shells 13, 14. The flange or flanges can be attached to the inner side of the half shells and can be adhesively bonded thereto, or be integrated into the layer structure of the half shells.

The region of the upper half shell 14 between the webs 15, 16 is shown in an enlarged manner in the upper region of FIG. 3. In this region, a fiber-reinforced composite material is provided on the outer skin of the half shell, which forms an outer layer 17, wherein a multi-directional fiber reinforcement can be provided in the outer layer. This can be implemented either by a combination of textiles with fiber layers, the angles of which are offset from one another, or by a single layer comprising many non-oriented fibers.

A second layer 18, which forms a flange in this case and is reinforced by predominantly unidirectional fibers, is provided beneath the first layer 17. This layer 18 is designed to be extremely rigid and has a high modulus of elasticity in the blade longitudinal direction.

A core layer 19 made up of foamed material or balsa wood, which primarily does not have a supporting function, but predominantly has a filling function, can be provided beneath the second layer 18. Another stabilization layer 20 is provided in the drawing beneath the core layer 19, which similarly to the first layer 17 comprises a multidirectional fiber reinforcement within a resin matrix.

In the end region of the webs 15, 16, narrow angles are provided on the inner side of the layer 20 with respect to the rotor blade profile, and thus shown in the drawing beneath the layer 20, which have a multidirectional fiber reinforcement and have the function of a receiving surface for adhesively bonding the webs to the flanges. These regions are denoted by reference numerals 21, 22.

The two webs 15, 16, as is apparent from FIG. 3, each comprise a core made up of foamed material or balsa wood, which is covered on both sides with a multidirectionally fiber-reinforced matrix. As a result of this sandwich design, the webs 15, 16 are designed to be buckling-proof.

The region of the rotor blade cross-section which is framed by the webs 15, 16 and the flange regions 18 is usually referred to as spar. The regions of the cross-section of the rotor blade which are load-bearing in the flapwise direction are usually arranged in the region of this spar. In addition, unidirectional fiber reinforcements in the form of flanges 18A, 18B can be introduced into the leading edge A and/or the trailing edge B, to absorb the load essentially in the edgewise direction. Except for the function of torsional rigidity, the remaining regions of the rotor blade do not contribute to the mechanical stabilization to a major degree and have a predominantly cross section-defining function, but have to be designed to be buckling-proof and can therefore be implemented in the manner of a sandwich comprising a core material made up of foamed material or balsa wood.

Since neither the position of the webs 15, 16, nor the position and width of the flanges 18, 18A, 18B is apparent on a rotor blade from the outside, the position, thickness and the resulting stiffness and mass of these elements forms variable design parameters within the scope of the described method, which are varied to such a degree that the target parameters are achieved. The method can be supplemented with supplemental restrictions of the optimization, such as strength calculations, fatigue calculations or stability calculations.

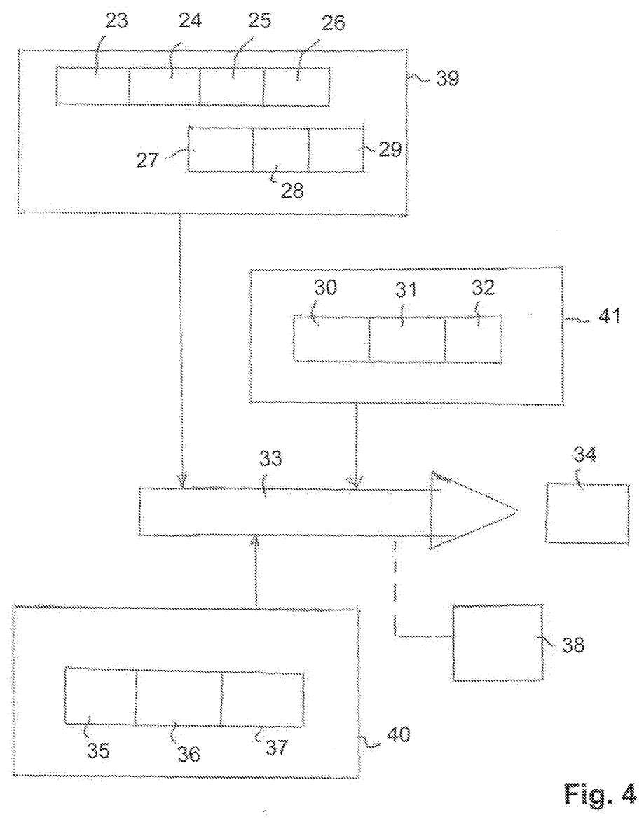

FIG. 4 schematically shows the structure of the method according to the invention. Quality parameters are shown in the region 39, which are determined and used during the optimization process 33. Corresponding quality parameters can, for example, be data of the outer geometry 23 of the rotor blade and/or topological data 24 and/or data about the laminate composition 25 of the outer skin. In addition, general installation parameters 26 can also be added as quality parameters, which can relate to other parts of a wind turbine, such as the tower and the foundation or to the coupling of the rotor to the tower.

In addition, the quality parameters of the region 39 can comprise material properties 27 of the materials used and/or production-induced influencing variables 28 and/or safety and reserve factors 29, on which the original design engineering was based and which, in many cases, can be derived from the manufacturer's information. If such information is not available, assumptions in this regard are made experimentally, which can be substantiated by visual inspection.

The quality parameters are supplied to the optimization process 33, that is, the parameters are practically supplied to a data processing program used in a data processing system, which carries out the optimization process.

In detail, it is also possible to utilize the infusion material used, the fiber material used, the fiber volume content as well as material safety factors and reserve factors as quality parameters. In addition, the outer dimensions of the rotor blade, such as the length and depth as well as thickness thereof, and the outer shape of the rotor blade, for example also the position of the chord are also possible. The cross-sectional contour of the rotor blade at various points along the longitudinal axis of the rotor blade can also be used as a quality parameter. In addition, the position of the chord of the rotor blade cross-sections can be measured in different longitudinal sections of the rotor blade and be introduced as quality parameters.

The total mass 35 of the rotor blade, the position of the center of mass 36, as well as modal properties 37 are possible target parameters, which are illustrated in region 40 of FIG. 4. The modal properties can be understood to mean the natural frequencies for different vibration modes as well as the eigenforms for certain vibration modes. Here, among other things, the flexural vibrations, torsional vibrations, and longitudinal vibrations, and the combinations or couplings thereof are possible vibration modes. During the selection of the harmonics for which the modal properties are determined and which are used in the method, it may apply that the first harmonic vibration and/or the first and second harmonic vibrations can be considered in each case. It is then possible to add at least one further of the first ten oscillation modes for the inclusion of the natural frequency and/or of the eigenform as a target parameter. Determining the modal properties can involve considerable complexity, however the result becomes more precise as the number of considered properties and as the number of included harmonics increase. The target parameters 40 are also supplied to the module, which carries out the optimization process or the optimization method.

During the course of the optimization method 33, the design variables 41 are included in the optimization process. These are varied to such a degree that the target parameters 40 are implemented in the calculation model, with the selected quality parameters 39 being specified.

The design parameters 41 can comprise the layer thicknesses 30, in particular of elements in the load-bearing regions of the rotor blade and/or the lamina orientation angles 31 defined by the position of the reinforcement fibers within the individual layers, and/or the pieces of information 32 about the flanges and webs of the rotor blade, for example the positions of the flanges and webs and the dimensions thereof in the s, t and z directions within the coordinate system used for the rotor blade. In the case of a sandwich-type design of flanges and/or webs and/or panel regions, the thickness of the filling regions between the cover layers is additionally a conceivable design parameter. The cover layers in the present connection shall be understood to mean the fiber-reinforced resin regions, while the filling regions are usually composed of balsa wood, a foamed material or another lightweight material that exhibits little tensile strength and pressure resistance relative to the fiber-reinforced resin regions.

After the quality parameters 39 and the target parameters 40 have been supplied to the optimization device or the optimization process 33, the design parameters 41 are varied until a model has been created in which the calculation results correspond to the target parameters.

For this purpose, the quality parameters 39, together with a starting model including the design parameters 41, are supplied to a computer program. The computer program carries out a modal analysis by way of a finite element method, using a shell or bar model. The variables determined during the modal analysis are compared to the target parameters. Based on the deviations established during the comparison, the design parameters 41 can be changed in a purposeful manner. A modified model including the changed design parameters 41 is then again supplied to the computer program. This is repeated until the determined variables have achieved the target parameters with an established accuracy.

When the target parameters are reached in this way, the design parameters 41 used for this purpose are also established. Overall, the bar properties 34 can be derived from the model that is available at this stage, and optionally the laminate plan can also be derived, as a function of the analysis that was carried out. If the laminate plan is determined as a further result of the optimization, it is possible to identify information about critical structural regions, for example in the form of the reserve factor, if a strength/fatigue/stability analysis was carried out. This may help the individual charged with conducting maintenance or the operator with the correlation with present damage and with the prediction of future damage.

In addition to the optimization specifications, which are specified in the standard optimization process 33, it is also possible to carry out strength calculations, fatigue calculations or stability calculations 38 based on the quality parameters and selected design parameters, so that additionally restrictions for the optimization process are created thereby. In this way, the result of the optimization process can be achieved more accurately and realistically.

1. A method for determining design parameters of a rotor blade of a machine interacting with a fluid, in which quality parameters of the rotor blade are determined non-destructively, in which target parameters of the rotor blade are determined, and in which the determined target parameters are predefined in an optimization process, wherein the design parameters are varied in the optimization process in such a way that the target parameters are achieved, taking the determined quality parameters into consideration.

2. The method according to claim 1, wherein the quality parameters used in the optimization process includes at least one of the following parameters: infusion material used, core material used, fiber material used, fiber volume content, at least one outer dimensions of the rotor blade.

3. The method according to claim 1, wherein the design parameters determined during the optimization process includes at least one of the following parameters: type and thickness of material layers of a shell of the rotor blade, reinforcement textiles used, a position, width of webs and flanges, and a distance of webs.

4. The method according to claim 1, wherein the target parameters used during the optimization process include at least one of the following parameters: modal properties, total mass, and a position of a center of mass of the rotor blade in a longitudinal direction thereof.

5. The method according to claim 4, wherein the modal properties include at least one of a first natural frequency of the rotor blade, a second natural frequency of the rotor blade, a third natural frequency of the rotor blade, a fourth natural frequency of the rotor blade, structural damping of the rotor blade, and an eigenform of the rotor blade with respect to at least one of the first, second, third, and fourth natural frequencies of the rotor blade.

6. The method according to claim 4, wherein the modal properties include at least one of a first natural frequency of the rotor blade, a second natural frequency of the rotor blade, a third natural frequency of the rotor blade, a fourth natural frequency of the rotor blade, a fifth natural frequency of the rotor blade, a sixth natural frequency of the rotor blade, a seventh natural frequency of the rotor blade, an eighth natural frequency of the rotor blade, a ninth natural frequency of the rotor blade, and a tenth natural frequency of the rotor blade.

7. The method according to claim 4, wherein the modal properties includes at least one eigenforms with respect to at least one of a first, second, third, fourth, fifth, sixth, seventh, eighth, ninth, and tenth natural frequency of the rotor blade.

8. The method according to claim 1, wherein the optimization process comprises modal analyses, and results of the modal analyses are compared to the target parameters.

9. The method according to claim 1, wherein the quality parameters are corrected based on a model for a production-induced change of material parameters.

10. The method according to claim 1, wherein at least one of a strength calculation, a fatigue calculation, and a stability calculation is carried out for an optimization.

11. The method according to claim 10, wherein at least one of a numerical model and an analytical model is used to evaluate limit states.

12. A method for determining parameters for the simulation of a machine interacting with a fluid, wherein quality parameters and target parameters of rotor blades of the machine are determined by non-destructive measurement, and design parameters of the rotor blades are determined according to the method according to claim 1.

13. A method for simulating a machine interacting with a fluid, wherein parameters for the simulation according to claim 12 are first determined, and thereupon the behavior of the machine under load is simulated.

14. The method according to claim 2, wherein the at least one outer dimension of the rotor blade comprises at least one of length, width of the rotor blade, angle of the exterior surfaces of the rotor blade, cross-sectional shapes for at least one position along the rotor blade, and a position of a profile center axis in a coordinate system of the rotor blade for at least one cross-section.

15. The method according to claim 3, wherein the design parameters determined during the optimization process include type and thickness of load bearing regions of the material layers of the shell of the rotor blade.

16. The method according to claim 3, wherein the rotor blade includes a plurality of webs and a plurality of flanges, and the design parameters determined during the optimization process include the stiffness and mass distribution of the plurality of webs and the plurality of flanges.

17. The method according to claim 3, wherein the rotor blade includes at least one of a plurality of webs and a plurality of flanges, and the design parameters determined during the optimization process include the angle of the at least one of the plurality of webs and the plurality of flanges with respect to one another.

18. The method according to claim 4, wherein the modal properties include at least one of a first natural frequency of the rotor blade, a second natural frequency of the rotor blade, structural damping of the rotor blade, and an eigenform of the rotor blade with respect to at least one of the first and second natural frequencies of the rotor blade.

19. The method according to claim 8, wherein the modal analyses use at least one of a shell model and a bar model.

20. The method according to claim 9, wherein the quality parameters comprise at least one of a fiber volume content and a resin absorption, and the at least one of the fiber volume content and the resin absorption is corrected based on the model for the production-induced change of material parameters.

21. The method according to claim 11, wherein the numerical model comprises a finite element model.

22. The method according to claim 11, wherein the analytical model comprises one of a volume, shell, plate, and bar model.
